(19) United States
(12) Patent Application Publication
(10) Pub. No.: US 2012/0238694 A1
(43) Pub. Date: Sep. 20, 2012

(54) POWDERED METASTABLE POLYMER MATERIAL

(75) Inventor: Beom-Jun Yi, Lyon (FR)

(73) Assignee: MERCURHONE, Lyon (FR)

(21) Appl. No.: 13/261,107

(22) PCT Filed: Jul. 2, 2010
(86) PCT No.: PCT/FR2010/000487

§ 371 Date: Feb. 27, 2012

(30) Foreign Application Priority Data
Jul. 6, 2009 (FR) 09/03311

(51) Int. Cl. C08L 17/00; C08K 3/04

(52) U.S. Cl. 524/574; 524/575.5; 524/590; 524/585; 524/586

(57) ABSTRACT

The novel group of polymers is presented under the name of Powdered Metastable Polymer Material (PMPM).

PMPM is in a chemically stable state at an ambient temperature of 25° C. for a relatively long time, but it is in a thermodynamically unstable state, and may change to either a stable state (in this case, re-vulcanization), or an unstable state (in this case, decomposition). According to the prior art, these PMPMs are, under various conditions, reactive, malleable, processable, compoundable, re-vulcanizable and re-polymerizable, and thus makes it possible to form new vulcanized or coagulated products, with or without moulds, with or without other polymers or elastomers, cross-linking agents, compatibilizers, various additives, etc.

PMPM is manufactured by a process known as metactivation, which applies to pre-vulcanized, polymer granules, a multi-directional microcracking by individual rotary compression and a disintegration by micro auto-explosion, thus obtaining a metastable state by virtue of activation enthalpy reduction, necessary for triggering a spontaneous reaction.

The classification of recycled rubbers in the forms of granules or powders, manufactured from pre-vulcanized rubbers is arranged in a table that classifies the typologies according to their scientific characteristics, which makes it possible to demonstrate the specificities of the PMPM.

The properties of this group, which are fundamentally novel, open the way to the complete reuse (material recycling) of pre-vulcanized polymers, such as used tires.

The following invention relates to the material(s), which is comprised of polymer particles smaller than 3 millimeters (mm) in diameter, of which the mass is a polymer compound mixed with diverse chemical substances used in the polymer industry, such as fillers (e.g. carbon black), vulcanizing agents (e.g. sulphur), peptizing oils (e.g. aromatic oil), activators (e.g. zinc oxide), accelerators, antioxidants, etc. This polymer material in particles are produced solely through a mechanical process , from pre-vulcanized gum granules (initial material), generally ranging in size from 1 to 5 mm, coming from used rubber products or items (e.g. used tires), rubber product wastes, rubber factory scraps, etc.

Now, it has been discovered that the aforementioned polymer material in particles, produced with granules from pre-vulcanized gum, after having already been treated by a mechanical-only process, does possess physico-chemical properties and rheological behaviour fundamentally different to the original materials, that is, granules of pre-vulcanized gum.

{Inventor uses in this invention,
the term “Vulcanization” in reference to “rubber cross-linking”
the term “Compound” designates “mixed rubber material or polymer with divers additives, such as fillers, vulcanizing agents, etc—generally used in the rubber and plastic industries”
the term “Gum” designates “an pre-vulcanized rubber compound ”
the term “Granules” designates “pre-vulcanized rubber pieces/granulates, that is, gum granulates, approximately 1 to 5 mm in diameter, which are used for the production of particles in the invention”
the term “Particle” designates “Particles smaller than 3 mm in diameter”
the term “Powder” designates “A mixture composed of particles smaller than 0.4 mm in diameter”}

Due to the absence of a scientific term, this new polymer material, in the form of particles or powder is named by the inventor “ Powdered Metastable Polymer Material (PMPM)”. This material is being subjected to a series of mechanical-only treatments, of which the principle is the object of the patent FR2946896 and another pending patent entitled “Metactivator”, EP2263785A1.

This PMPM is produced from vulcanized gum pieces/granules, by virtue of a complete mechanical treatment applied by a machine named “metactivator”. PMPM also can be manufactured, under particular and variable physical conditions, by mill grinders, ball mills, crackers, pulverizers, extruders, micronizers, disk mills, high shear mills, high energy ball mills, planetary ball mills, etc.—, of which the main objective is the reduction in size of the materials.

Vulcanized polymers/ elastomers or vulcanized polymer compounds, from which PMPM is produced, are essentially:
vulcanized elastomers: vulcanized rubbers of NR, IR, BR, SBR, IIR, NBR, CR, EPDM, EPM, CSM, Silicone rubber, Fluor rubber, etc—granules of used tire gum
vulcanized thermoplastics, such as XLPE
thermoset plastics: polyurethane, epoxy
mixture of thermoplastics and vulcanized elastomers: co-extruded pieces or co-injected pieces of polypropylene and EPDM, for example.

According to the commonly accepted idea in the polymer industry, which Goodyear invented in 1839, the vulcanization by sulphur, vulcanized rubbers/rubber compounds are considered inert or inactive, therefore, they are neither re-compoundable, nor re-vulcanizable. Consequently, they are not re-useable as virgin rubber or a green compound.

Contrary to this idea, the inventor observed that the PMPM, even if produced from pre-vulcanized rubber, possesses physico-chemical and energetic properties different to those granules of vulcanized rubber gum of origin. Their behaviour, when utilized, resembles more that of virgin rubber/green compound than the initial vulcanized rubber because the aforementioned PMPM demonstrates properties of auto-adhesion, of cohesion, of adhesion with other polymers, of decomposition over a short term, of re-vulcanization, etc.—which are unfamiliar to the original vulcanized rubber/polymers. These properties of PMPM, which are fundamentally new, open the way to a total and general re-use (material recycling) of vulcanized rubbers.

The annexed figures illustrate the concept and application of this invention:

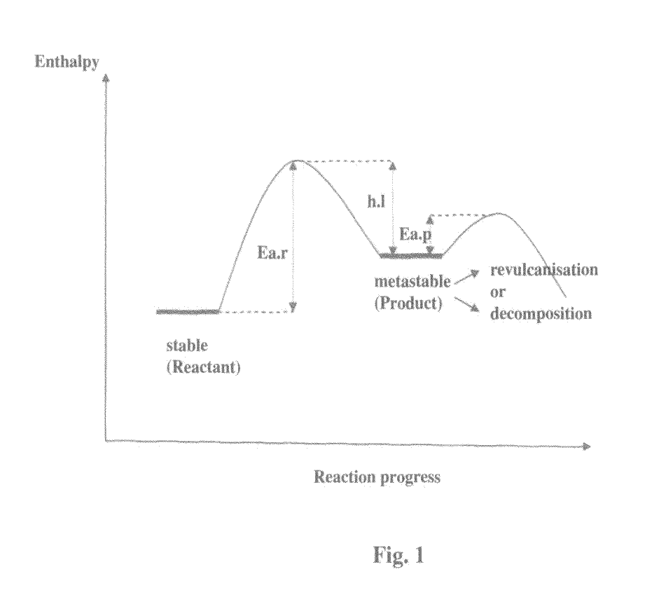

FIG. 1 presents the novel concept of metastability of metastable rubber/rubber compound, named Product, obtained from pre-vulcanized rubber/rubber compound, named Reactant (the initial material) . The major part of scientific data from this invention has been obtained from the analysis of used tire's gum granules, employed in this invention as Reactant. The caption is as follows: The rubber system metastability. Product, the metastable rubber/rubber compound, is produced from pre-vulcanized rubber (=Reactant),which is considered as stable. The Metastable State can be evolved towards either as a newly Stable State (Re-Vulcanization), or as an Unstable State (definite Decomposition).

Ea.r: Activation Enthalpy applied to Reactant by mechanical-only operation

h.l: Heat Loss

Ea.p: Activation Enthalpy of Product

{Inventor does not use the term “metastable Product” in the sense of “transitory Product” or “intermediate Product”, which exists during the transitory phase, as used in “Theory of Collision”, but, as a “quasi-stable product” obtained after the transitory phase}

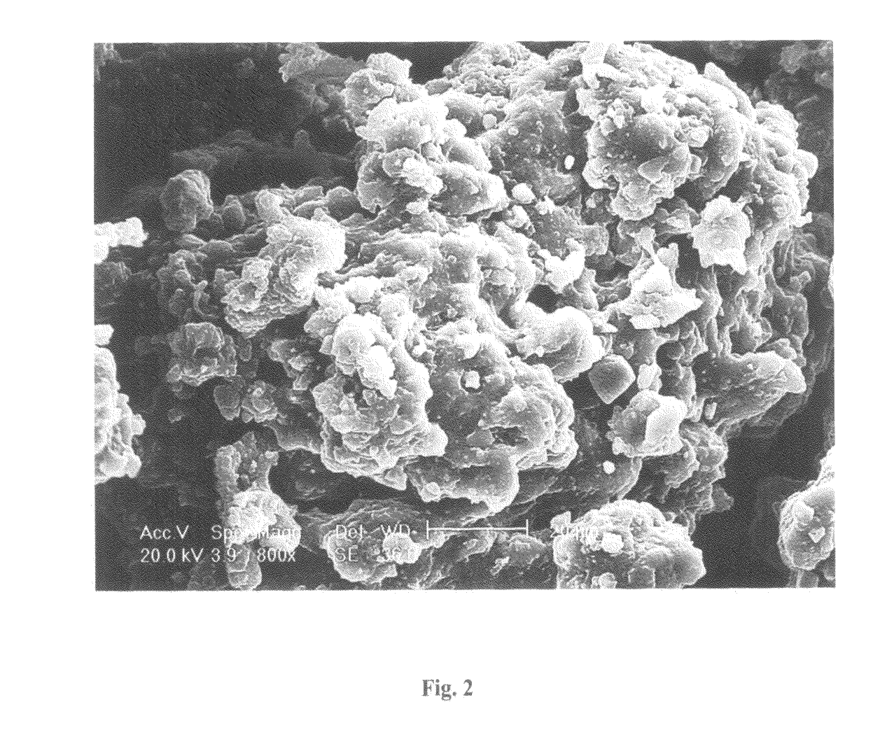

FIG. 2 is a SEM photograph of Product, PMPM, with, on the surface, micro-grains, which are more or less spherical and about 1 to 20 microns in diameter.

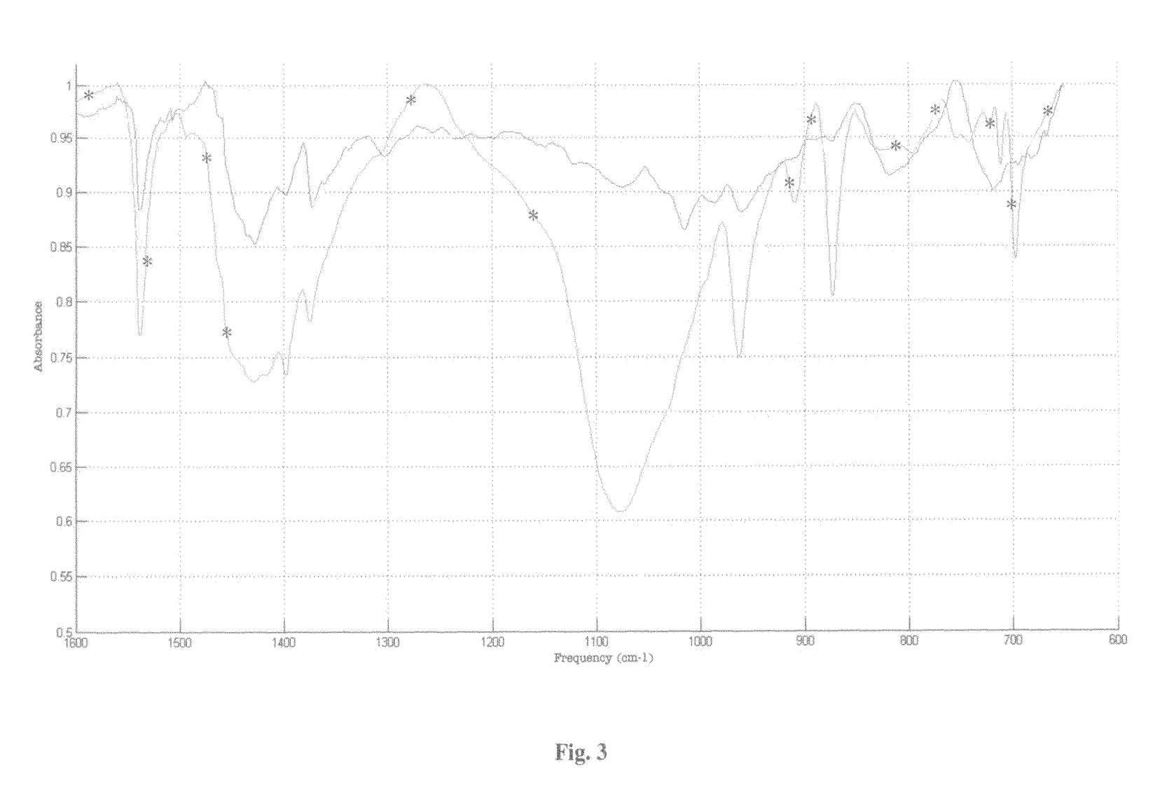

FIG. 3 is a diagram of FT-IR spectroscopy between 650-1600 frequency (wave number/cm) of a Reactant and a Product (curve with stars).

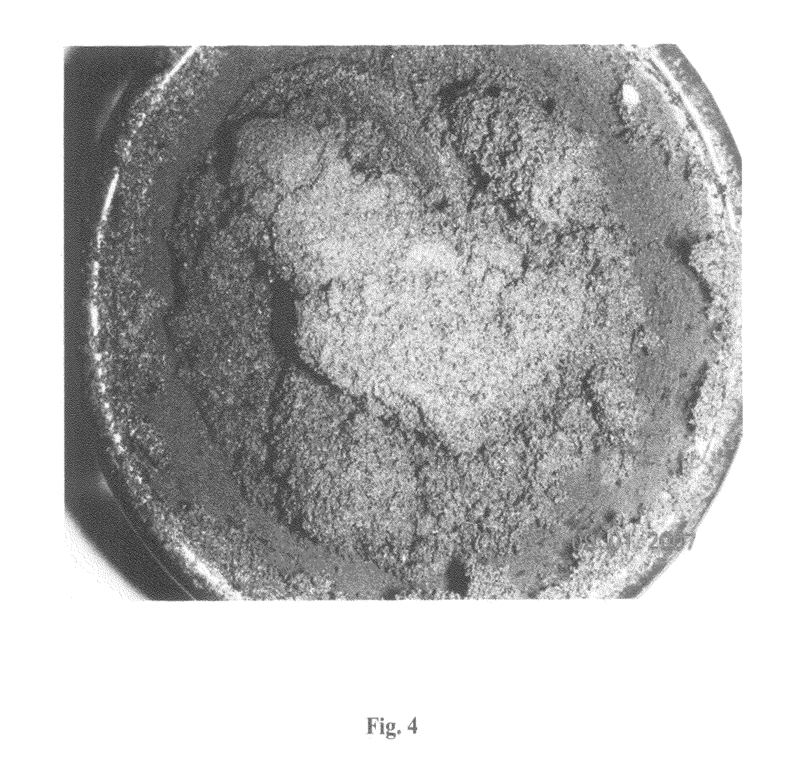

FIG. 4 is a photograph which shows the auto-adhesion state of PMPM

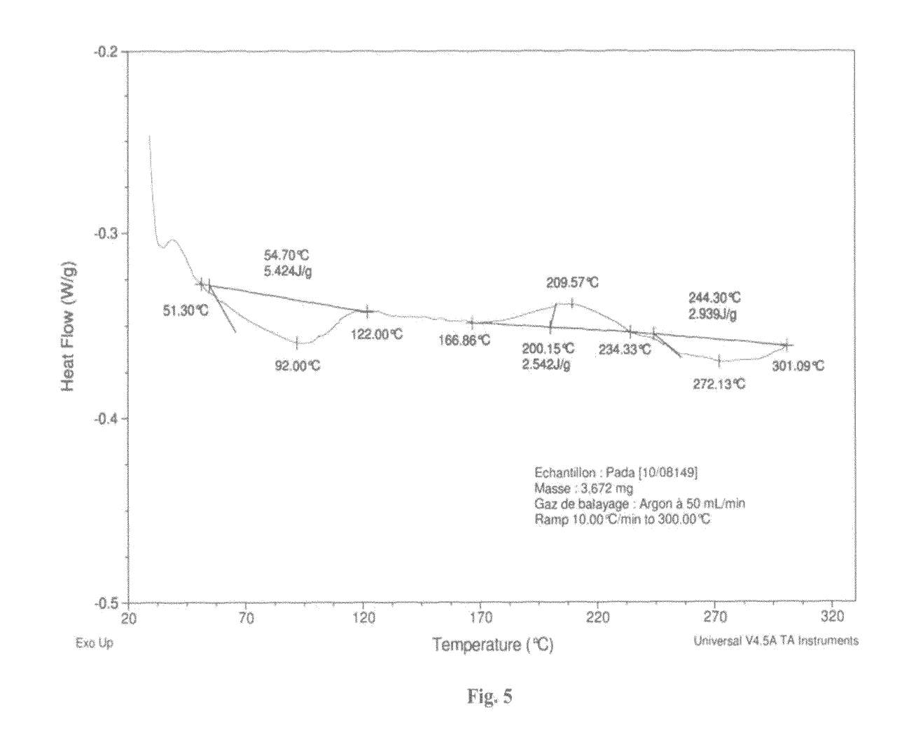

FIG. 5 is an example diagram of DSC/MDSC analysis of PMPM obtained from used tire's gum granules.

Tab. 1 summarizes the features of three groups of granules/powders manufactured from vulcanized rubbers or vulcanised rubber compounds.

This novel concept of metastability of a polymer or elastomer system is defined as follows: As described in FIG. 1, a pre-vulcanized elastomer/elastomer compound, Reactant, is considered as stable because the structure is literary inert, inactive or fixed, and can not be changed in nature for a long time, 25 years, or even 50 years. When the aforementioned Reactant, for example, 3 mm granules of used tires gum, is treated by a machine, for example, by the metactivator, the mechanical energy is applied into the granule mass, Reactant, and, thus has an effect on the structural and energetic level of the granule mass.

Following the aforementioned mechanical treatments, pre-vulcanized gum granules or materials, Reactant, is transformed into particles or powders, which size becomes on average smaller than that of the original granules. The end result particles are millimeters or microns in diameter, and are separated or slightly attached to each other. The surface of these particles has a particular shape with more or less spherical micro-grains of, in general, 1-20 microns in diameter, which resemble the grains inside a pomegranate, as shown in photograph, FIG. 2

In reality, during this mechanical-only process, two physical phenomena occur within the mass of Reactant, i.e. pre-vulcanized rubber granules, as explained in the other patent FR2947555:
At first, a mechanical micro-cracking in all azimuth of the gum granules, through individual rotational compression, and
Then, the disintegration of the mass by virtue of micro auto-explosion, which brings about a transformation of the granules into particles or powders, of which the size is on average smaller than the initial granule's size, and simultaneously, the physico-chemical and energetic modification within polymer mass of Reactant.

Scientific measurements and analysis performed on this new material, PMPM, produced in particular from used tire's gum granules, have the following characteristics:

Shape: The surface of PMPM particle shows a particular shape with micro-grains of 1 to 20 microns more or less spherical, similar to the grains inside a pomegranate. These micro-grains are visible with SEM photography on a particle surface as shown in FIG. 2. This morphology proves that the surface is not the result of cutting or slicing by a kind of knife, or detached by stretching, or simply torn by shearing, but, rather shows an exploded state from inside the mass by an expanding force or releasing force. The most natural shape resulting from this phenomenon is a more or less spherical shape, with a minimum external surface, like a drop of water. Thus, these more or less spherical micro-grains, irregularly spread out over all the PMPM particles, prove that the components or the micro structures formed at the moment of original vulcanization were self - exploded or disintegrated by sudden decompression or expansion, without adding foreign chemical substances.

Size (mm): measured by granulometry after sieving, the size in diameter of Product particles, identified at the peak position of the Gaussian curve, is on average 2 to 15 times smaller than Reactant, the initial material, i.e. pre-vulcanized gum granules (e.g. gum granules of used tires, or vulcanized EPDM, or vulcanized IR, etc—). This means that the size, which was initially approximately 3 mm in diameter is now 0.2 mm-0.8 mm-1.5 mm, depending on the original material and effectiveness of the treatment, for instance, by metactivator.

{Inventor uses the term “on average” to designate “the statistical mean calculated from 20-30 samples”}

Bulk density (g/cm³): measured by tapping on Product, the bulk density is on average, 5 to 20% smaller than Reactant, the initial material, i.e. pre-vulcanized gum granules. For example, bulk densities of used tire's gum granules, i.e. Reactant, is 0.494 g/cm³, and that of Product (PMPM) is 0.454 g/cm³. In this case, the bulk density of Product is decreased on average by 10% in comparison to vulcanized gum granules, Reactant. This result shows a volume expansion or a “puffing up” of Product in comparison to Reactant.

Specific surface (cm²/g): measured by the BET method with Krypton, the specific surface of Product is on average 5 to 20 times higher than that of Reactant, the initial material, (i.e. pre-vulcanized gum granules). Nevertheless, absolute values are very low: less than 0.01 cm²/g for Reactant measuring 2-3 mm, 0.07 cm²/g for a Product measuring 0.4-0.8 mm, and 0.08 cm²/g for a Product measuring inferior to 0.4 mm. Even if the specific surface of Product is 8 times higher (0.08 divided by 0.01) than that of Reactant, these absolute values, even less than 0.1 cm²/g, are not significant enough to explain the fundamentally new behaviour of Product. Yet, the microscopic increase of 0.07 cm²/g (0.08 minus 0.01) gives evidence of a small increase in the reactive surface area, and, can lead to slight reinforcement of an adhesion effect or swelling at the level of Product surface.

Specific heat Cp (J/° C. g): measured by the DSC/MDSC method, the specific heat of Product is on average 5 to 20% higher than that of Reactant, the initial material (i.e. the pre-vulcanized gum granules). For example, the Cp of the Product (i.e. PMPM of used tire's gum granules) is higher than that of the Reactant (i.e. used tire gum granules). The Cp of Reactant are 1.5 J/g at 30° C. and 1.8 J/g at 160° C. while those of Products are respectively 1.79 J/g, and 2.04 J/g . These values indicate a structural phase modification of the initial material, Reactant, and, an expanded structure of Product in comparison to the Reactant, as well as the entropy evolution of the system.

Devulcanization rate (%): measured by the Swelling technique of Gel fraction according to the Soxhlet method and the Flory-Rehner equation, the rate is more than 20%, but varies between 20 and 90%, depending on the initial material, i.e. pre-vulcanized gum granules, treatment conditions and Reactant typologies. The higher the rate, the more sulphur bonds are considered to be broken. This is the reason why the rate of at least 20% indicates a partial devulcanization state of Product as compared to that of Reactant. The FT-IR analysis gives evidence of significant modifications of polysulfide bonds, C—S, S—S, etc.—, and an increase of specific heat Cp of Product, PMPM, which indirectly demonstrates a partial devulcanization of Product.

{Devulcanization means breakage/cleavage of sulphur bonds or other chemical bonds of cross-linking. Due to the variety of vulcanized materials, fillers percentages, etc.—, the rate is inevitably, quite variable. Researchers have already found that sulphur bonds break 33 times easier than that of carbon backbones when stretching, shearing or expansion forces are applied}

Depolymerization (or, degradation) rate (%): measured by Gel fraction using the Soxhlet method, the rate is less than 30%, but is variable between 3% and 30%, depending on the initial material, i.e. pre-vulcanized gum granules, treatment conditions and Reactant typologies. This rate indicates a partial degradation state of Product as compared to that of Reactant. The depolymerizied state is also observed on FT-IR analysis, which shows a deep modification of the polymer carbon backbone bonds, —C—C—C, —CH, —CH₂, —CH₃, etc . . .

{Depolymerization means scission/breaking of carbon backbones}

Expansion rate: measured by pycnometry, the expansion rate of Product, PMPM, compared to that of Reactant varies on average from 1.01 to 1.40 depending on typologies of initial material, i.e. pre-vulcanized gum granules. This rate is calculated from the ratio between the specific volume (cm³/Kg) of input material (before treatment) and output material (after treatment) of a machine, metactivator. For example, for granules of 3 mm in diameter of used tires gum (input material into the machine), the specific volume is 848 cm³/kg, and that of Product (i.e. powder 0.4 mm, output material) is 956 cm³/kg. In this case, the ratio 1.127 (956/848=1.127) is calculated and named as expansion rate or micro auto-explosion rate of the obtained material, Product, which means that the specific volume of Product, PMPM is increased by 1.127 times in comparison to Reactant. This result in the expansion rate indicates clearly that, just like the measurement of specific surface BET, and, also bulk density, the interior structure state of PMPM is “puffed up”, relaxed or expanded, but, without holes on the scale of 20 microns, inside the mass, as observed in FIG. 2.

{To describe the nature of this particular structure, the inventor uses the term “expanded structure”. In this sort of expanded structure, it is also observed in nanotechnology, mechanochemistry, quantum mechanics under the term “volume expansion”, “bond stretching”, —, certain bonds are broken, some are modified, while others are released or extended, and some are re-formed compared to the original structure. In summary, molecular or atomic bonds, even at the level of orbitals, became weaker or were easier to break down than the bonds of the initial structure, Reactant, which resulted in the decrease of bonds dissociation energy (De).

Regarding the case of vulcanized rubber, during the sudden decompression or expansion or micro auto-explosion described in patent FR2946896, carbon black bonds in the Reactant gum are inevitably stretched or broken, carbon backbones are broken, modified, or loosened, and polysulfide bonds are also broken, detached or reformed,—Thereby, an expanded or relaxed structure is obtained}

Micro disintegration: in the mass of an expanded structure, PMPM, the inventor found proof of the existence of nanometric slits on the molecular/ atomic dimension level, around the micro-grains of 1-20 microns. In practice, the expanded structure mass of PMPM particles is micro-disintegrated, or micro-separated or micro-pulverized, observed under a microscope, into a large number on average 20-3,000, of micro-grains sized 1-20 microns by mechano-physical ways (e.g. extrusion, kneading, pressure, heat) or, by chemical substances (e.g. THF, phenols). For instance, one 400 micron particle of PMPM is disintegrated or dispersed into 20-400 micro-grains. In this way, the inventor found that 400 microns particle of PMPM does not behave as one massed particle, but, a hundreds of separated micro-grains approximately between 1-20 microns, which integrate easily into many sorts of diverse polymer material matrix. Regarding the industrial re-use, this specificity of micro disintegration, particular to PMPM, is the fundamental reason for its polyvalence and omnipotence.

{The inventor has logically deduced that, these slits around micro-grains of 1-20 microns, are due to voids/cavities/flaws created at the points where molecular/atomic chains/liaisons/bonds, and/or carbon blacks aggregates, are broken/detached/deformed/stretched by the mechanical operation of metactivator. For the future, the inventor hopes that, the existence of these slits and voids/cavities/flaws can be calculated or proved by means of physics or quantum physics}

Exothermic reaction: according to FIG. 5, there is a fundamental difference on the level of thermal reaction between Product and Reactant, in the case of used tires gum. In fact, the thermal reaction of Product, measured by Argon DSC/MDSC shows an endothermic reaction of up to approximately 80° C., but, afterward, a clearly exothermic reaction of about 80° C. to 140° C., and, thereafter, of 160° C. up to about 210° C., While it is known that Reactant, in the case of used tires gum, registers an endothermic reaction roughly on a whole range of temperatures up to 300° C. These thermal reaction results indicate that, in nature at the ambient temperature of 25° C., Product, PMPM, remains endothermic, therefore, without spontaneous reaction just like Reactant. But, contrary to Reactant, Product displays an exothermic reaction, that is, a spontaneous reaction or a re-forming of molecular bonds, from about 80° C. up to about 210° C., with a large exothermic amplitude.

FT-IR spectroscopy: according to FIG. 3, the IR absorption variation pattern of Product, produced from used tire's gum granules, is different to that of Reactant. The absorption/ absorbance rate of Product, PMPM, is about 2 to 5 times higher than that of Reactant, used tire's gum granules (initial material, i.e. pre-vulcanized gum granules), particularly near IR frequency 700, 880, 920, 970, 1060, 1000-1250, 1372, 1447, 1539 and 2915 between 650 and 4000. This change in IR vibration pattern demonstrates a structural modification of the complex molecular bonds of Reactant.

In summary, as seen through scientific analysis, the specific characteristics which differentiate Product (i.e. PMPM of used tires gum) from Reactant (i.e. pre-vulcanized gum granules of used tires) are as follows
Product has a particular surface with micro-grains of about 1- 20 microns, more or less round, which means that Product has less surface tension and has a more reactive area than Reactant.
Product has an expanded structure, wherein, for example, carbon black molecular bonds inside of Product are easier to break down than that of Reactant.
The molecular bonding state of Reactant is deeply modified, meaning that a drastic change of the structural phase and energetic state has occurred within the Reactant mass so as to form a new state at the Product level.
Reactant devulcanization and depolymerization have taken place, but, in different proportions.
In nature, at 25° C., Product, PMPM, manufactured from used tire's gum granules, remains stable for a relatively long term, even several years, but, starting at about 80° C., a re-forming of the molecular bonds takes place.

All of these characteristics related to the size and shape transformation, the physico-chemical and energetic state modification, etc.—of Reactant can cause new or different behaviour to the level of Product, when Product is used.

In fact, the new properties which enable another way/principle, in order to re-utilize Product, PMPM, in contrast with Reactant, are observed in the following phenomena:

Auto-adhesion: PMPM of used tires gum, for example, is heated to about 100° C. -160° C. momentarily for approximately 10 minutes, and, afterward, cooled at ambient temperature. After one week, or even several weeks, these particles or powders self-attached to each other to form one coagulated mass, as presented in FIG. 4, which is also slightly elastic. This phenomenon is known under the term “autohesion” or “auto-adhesion” of virgin polymers, which designates an inter-diffusion of polymer matrix only through the heating process. This auto-adhered state of PMPM remains unchanged for a long time, even for several years

Decomposition: PMPM decomposes in the short term under the effect of peptizers, heating, etc—for several weeks, even several months in nature. Following this slow and natural evolution, the aforementioned PMPM is dissociated overall into two parts, that is, the polymeric liquid substance and the carbon black. To verify these phenomena occur in a short time period, aromatic oils between 10%-20% of PMPM's weight were added to PMPM of used tires gum, and heated to 100° C. -160° C. momentarily, for up to 10 minutes, and, afterward, cooled in ambient temperature for two weeks. The inventor observed that the appearance and finger-touching texture of Product changed very slowly, even when not discernible, at times, under direct sunlight, by way of substances dissociation or decomposition.

Cohesion: 100% of the PMPM of used tires gum, without any other additive substances, are compacted together and compressed under pressure (50 kg/cm²) in a Plunger type mold, at 190° C.-210° C. After 20 minutes, these particles or powders have newly adhered to form one real rubber piece, which has a tensile strength of about 5 MPa or more, while the PMPM produced from certain vulcanized EPDM coagulates in the same manner at the end of 6 minutes.

Adhesion with other kinds of polymers
Adhesion with other elastomers: Product, PMPM, coagulates with other rubbers, even with those which in principle are not miscible or compatible with it. For example, in the same process used for the previous cohesion, PMPM of used tires gum granules was mixed and molded with PMPM, produced from pre-vulcanized EPDM. This compression molding gives one real rubber piece, the same as in the case of the previous cohesion.
Adhesion with thermoplastics: The mixture of one sort of PMPMs, a Product from used tires gum, or vulcanized EPDM, or vulcanized NR, or vulcanized IR, etc—, and, one sort of polypropylene granules or polyethylene granules, or polyamide granules, ABS granules, etc.—is injection pressed, with or without additives, —. From these mixing trials, diverse values of tensile strength, elongation, etc—are achieved. In this way, plastic compounders pre-mix PMPMs with many kinds of thermoplastics, polyethylene, polypropylene,—in order to manufacture TPE/TPV granules.

{The autohesion phenomena , decomposition in the short term, and adhesion were discovered by chance during test operations carried out in a rubber factory in 2006. After producing PMPM from used tires granules, tests and trials were conducted in order to transform this powdered material into a coagulated mass, so as to be able to employ normal molds, which are generally used in the rubber industry for the manufacturing of rubber articles, because Plunger type molds are neither practical nor profitable from an industrial point of view.

Adhesion case: Nevertheless, this powdered material, PMPM, after diverse trial mixing in a Banbury mixer, unfortunately always yielded a powder form, but, not in a coagulated or an attached mass, like bale rubber. So, all trial samples, which were always in powder form, were stocked in containers, and abandoned as waste in a corner of the factory. After several weeks, when a worker came to throw away these rubber wastes, the worker discovered totally coagulated PMPM masses like rubber bale instead of powdered PMPMs. After this incident, the inventor observed that PMPM produced from other sort of vulcanized rubber, for example, a very elastic vulcanized IR rubber, self-adheres at certain temperature just after output from the machine, metactivator.

Decomposition case: During compounding trials, PMPMs were mixed and momentarily heated with aromatic oils, or other additives, etc.—, and, certain samples of used tires gum were stored away. Even some weeks after treatment, no visible and evident appearance changes were observed. But, after some months, 3-4 months, when the inventor came back by chance to discard the samples, the inventor found a complete separation between polymeric liquid substances and carbon black, which meant a complete short term decomposition.

That is how the inventor came to understand that autohesion, decomposition and adhesion of PMPM of used tire's gum granules had a very slow reaction in nature, visible to the naked eye only after one week or several months}

Yet, the acknowledgement of these 4 phenomena, autohesion, decomposition in short term, cohesion and adhesion around the original vulcanization temperature of between 160-200° C. depending on the Product typologies, PMPMs, is impossible to observe in pre-vulcanized rubber/rubber compounds, which are considered inert, inactive or fixed, hence are stable for a long time, 25 years, even 50 years. On the other hand, these four phenomena are more characteristically from virgin rubber or a green rubber compound, from which Product is not derived.

In other words, these observed states also mean that
PMPM is neither vulcanized rubber nor a green compound, but, it behaves in part as vulcanized rubber/rubber compound, and in part, as virgin rubber/ green compound.
PMPM, even produced from vulcanized rubber/green compound, behaves as virgin rubber/rubber compounds in respect to, for example, autohesion faculty.
PMPM, with its own characteristics, shows a spontaneous reaction, therefore, an evolution potential, contrary to vulcanized rubber/rubber compounds, which structure is inert, inactive or fixed for a long time.
PMPM is chemically stable at ambient temperature (25° C.) for a relatively long period, but in a thermodynamically reactive state, which means its structure is changeable when external factors intervene into the system, and is scalable towards either re-stable state (Re-vulcanization), or unstable state (Decomposition), as presented in FIG. 1.

This unexpected fact is of major importance in polymer history because it implies the existence of another polymeric state situated between virgin/unstable state and vulcanized/ stable state on the level of polymers/ polymer compounds. In other word, this another state can be expressed as quasi-stable or “metastable state”.

Thus, the Product manufactured from wastes of polymers/vulcanized polymer compounds of NR, IR, EPDM, used tires, polyurethane, XLPE,—are named by the inventor “Powdered Metastable Polymer Material (PMPM)”.

It must also be noted that the aforementioned PMPM has its own reaction pattern which is different from the initial vulcanizing process of virgin elastomer or green compound. For example, adding sulphur as a cross-linking agent, increases hardness without real improvement of tensile strength, or, mixing peptizers accelerates in a short time the dissociation or decomposition of PMPM substances.

The search for scientific explanations behind this transformation in the properties of Reactant into Product, PMPM, is presently in progress. Nevertheless, without link to any already approved theory, the inventor explains these phenomena in accordance to two scientific bases: on a chemical base, the functionalization of Reactant, and, on an energetic base, since all chemical reactions are due to the re-organization of an energy state. A part of the inventor's reflection, based on the energetic aspect in regards to enthalpy, entropy, Gibbs free enthalpy, activation enthalpy, etc.—is presented in this invention.

{Before contemplating the thermodynamics of PMPM, the very structural nature of the mass of vulcanized rubber/rubber compound granules must be taken into consideration: According to statistical mechanics description, a granule mass is a complex, macro state of components, or the ensemble of micro structures or micro states of chemical bonds. Thus, the measured physico-chemical or energetic data are related to the behaviour of all of these micro structures, but, not only to a specific or partial state. It is essential to interpret the results of the physico-chemical analysis as a global indicator of the sum of these micro structures, but, not only for one state composed of, for example a mono- or polysulfide, or, for the part of the rubber carbon backbone. Moreover, it must not be forgotten that the PMPM system in nature is a macro state open to constant pressure, but, at variable temperatures}

Enthalpy: enthalpy H means the ensemble of internal energy U and PV, of which internal energy U comprises kinetic energy (KE) of molecular and atomic bonds, and potential energy (PE), that is, H=U+PV=KE+PE+PV.

In view of the very diverse vibration patterns observed in the FT-IR analysis, the kinetic energy of PMPM is estimated to increase, as well as potential energy based on specific heat Cp and expansion rate of PMPM. Thus, the enthalpy of the PMPM system is considered higher than that of Reactant, as presented in FIG. 1

{Real evolution of KE and PE of Product, a macro state, consisting of micro components or molecular or atomic structures, is a complicated subject regarding the present level of scientific knowledge relative to physics, mechanochemistry, or quantum mechanics. Then, Product is considered logically as having an increased enthalpy (KE+PE) or increased internal energy compared to Reactant. The inventor wishes that research on this subject, continues to get more scientific information on the real nature of PMPMs macro-state}

Entropy: in a classic sense, entropy S=m Cp/T (J/° C. g or J/° C. mol) of the system, PMPM, has increased compared to that of the Reactant, as show in Cp values.

(Inventor use s the term “entropy” only in the sense of classic thermodynamics, S=Q/T=(U+W)/T or S=m Cp/T, for instance, at 30° C. and 160° C., excluding its possible application in mechanical statistics or information entropy, S=K Σ log P. The inventor did the same theoretical reflection on the entropy concept in 1978 when he wrote his PhD thesis, in trying to apply this concept to the aquatic ecosystem in the purpose of defining “disorder state” “stability” or “instability” of an ecological system.

Nevertheless, after long reflection, the inventor has decided to confine the application of the term “entropy” in only the classical thermodynamic sense, because the relevant system, vulcanized rubber particle or an aquatic ecosystem, is an ensemble, a macro state comprising very heterogeneous micro states in relation to atoms, C, H, S, -, or, extremely autonomous beings, to which the entropy concept of statistical mechanics or “information entropy” can not be applied directly at this moment. According to statistical mechanics or “information entropy”, each micro state is assumed accessible at the same level. But, the system of PMPM does not satisfy this necessary condition, except if a scientific, statistical or quantum method for this application is available in the future)

Gibbs free enthalpy (or, energy): The evolution pattern of free energy G in PMPM of used tires gum granules, under constant pressure, but at variable temperatures, is completely different than that of the initial system of used tire's gum granules, Reactant :
Until about 80° C., PMPM of used tires gum shows an endothermic reaction, therefore, neither re-forming molecular bonds, nor spontaneous reaction occurs. In this situation, ΔG is always assumed to be positive, then, ΔH>TΔS.
Between about 80° C. -210° C., PMPM of used tires gum shows an exothermic reaction, therefore, re-forming molecular bonds or a spontaneous reaction effectively occurs. In this situation, ΔG is assumed as negative, thus, ΔH<TΔS. For example, ΔG=G at 140° C.-G at 50° C., is assumed negative.
Above approximately 210° C., PMPM of used tires gum shows an endothermic reaction, therefore, neither re-forming of molecular bonds, nor spontaneous reactions occur. In this situation, ΔG of Product is assumed to be positive, then, ΔH>TΔS, contrasting with Reactant (i.e. used tire's gum granules) which shows an endothermic reaction in almost whole ranges of temperatures 25-80-210° C., until about 300° C., then, neither re-forming molecular bonds, nor spontaneous reaction occur.

{Free energy G is not a real energy which can be conserved, transformed or exchanged, even it is presented by the same dimension as energy, J/g or J/mol. Free energy G, defined as G=H−TS, is a calculated number indirectly based on physical, real values, but, not a direct measured value by an instrument. Combined with exothermic, exergonic, equilibrium data, this is a very useful concept to visualize or to understand in particular the direction and the force of spontaneous reaction.

According to the concept of Free energy G, chemical reaction makes headway in the direction where the system energy state moves towards, so that the system energy state can be re-organized, that is, the chemical reaction is a consequence of re-distribution or re-dispersion of system energy. Yet, in order to change the energy state of a system, at variable temperatures, the entropy TS, must be higher than enthalpy H (=KE+PE). This conceptual difference, H-TS, is named in theory as Gibbs free energy. As long as the difference is not a negative value, spontaneous reaction will not occur. A positive or negative value of G indicates which is the higher value between H and TS}

Activation enthalpy (Ea): in PMPM of used tire's gum granules, two important changes are observed .
Reaction lead time of coagulation and cohesion of several types of PMPM were very short, 6, 10, 20 minutes.
Exothermic reaction temperature of PMPM was clearly low, about 80° C., compared to that of Reactant, which shows roughly an exothermic reaction above 300° C., when it transforms into viscous fluid or gas.

Consequently, these modifications mean that PMPM system reacts at lower or smaller Ea than that of Reactant, or, that PMPM needs less activation energy to trigger a spontaneous reaction. For this reason, the applied mechanical-only process, is named metactivation, which is defined as “Activation of an energy state by a metastabilization mechanism, so that the activation enthalpy is decreased, or activation barrier is lowered”, as presented in FIG. 1

{the definition of Ea (sometimes, also, called activation barrier) is the minimum quantity of energy/enthalpy, which is necessary to trigger a reaction. In chemical reactions, the lower the Ea, the faster the reaction.

In the case of PMPM , the inventor prefers the more exact term, “activation enthalpy” used in “theory of transitory state” to “activation energy” used in “theory of collision”, because enthalpy designates internal energy U(KE+PE), whereas activation energy designates often only PE}

On a commercial aspect, PMPM is distinct from divers kinds of recycled rubber/rubber compounds, called devulcanized or ground vulcanized rubber or reclaimed rubber, etc—, which are commercialized in the form of granules or powders or in bale. These recycled rubbers are classified into three groups in table 1: ground rubber, metastable rubber compounds from this invention, and devulcanized or depolymerised rubber, according to scientific characteristics:

Group 1: These are granules/powders made with used rubbers (e.g. used tires gum) or vulcanized rubber wastes, etc.—through simple grinding, not applying excessive heat. The first inventor of this sort of recycled granules/ powders was Charles Goodyear in 1853 (British patent number 2933). These ground granules or powders, even very fine at 120 mesh, are always in a vulcanized state, therefore, inert and inactive, and, can be stuck together only thanks to special binders, as polyurethane, latex, etc—to make a single-massed piece/item. However, this stuck state can last in theory only a few years.

Group 3: These are heated, vulcanized rubber/rubber compounds, up to a very high temperature, 300° C., with or without pressure, and with or without additives. These heated rubbers are sold in bale or fine granule forms and used as fillers, but not as an elastomer due to the absence of elasticity. The first inventor who made this kind of heated rubber from waste rubbers was Charles Morey, U.S. Pat. No. 12,212 (1855). These strongly devulcanized and also highly depolymerized or degraded rubber/rubber compounds have little commercial value, due in particular to its high production cost, compared to market prices of other fillers used in the rubber industry.

Group 2: These are novel kind of rubber/rubber compounds, metastable, aforementioned in this invention. Contrary to granules/ powders of Group 1, this new product, in powder form, is reactive, therefore, re-compoundable and re-vulcanizable, that is, the quality which permits re-making of real rubber or elastomer articles. According to industrial experiences, the best quality PMPM is manufactured from used tires gum or vulcanized rubber wastes which is obtained by virtue of a maximum rate of devulcanization and, simultaneously, a minimum depolymerization rate, realized by, for example, the metactivator.

In conclusion, Powdered Metastable Polymer Materials, PMPMs, produced from diverse pre-vulcanized polymers or elastomers/polymer compounds form a novel group of polymers/polymers compounds , by virtue of its own properties and utilization methods, so that, the group of PMPMs is distinct, not only to the group of virgin polymers/green compounds, but also, to the other group of vulcanized polymer/polymer compounds. In other words, the PMPMs group possesses, on one hand, elastic property with the same chemical composition as of the origin, similar to vulcanized polymers/polymers compounds, and, on the other hand, the faculties of autohesion, decomposition in the short term, cohesion, adhesion, in summary, re-vulcanization capacity, similar to the group of virgin polymers/green compounds.

The discovery of this novel group of polymers/polymer compounds in metastable state for a relatively long term, situated between virgin polymers in unstable state, and vulcanized polymers in stable state, is a major important event in the history of the polymer industry because it opens a way towards total re-use (material recycling as a raw material) of vulcanized rubber wastes.

The aforementioned PMPM, of which the utilization or application art has been under development since 2008, is indeed reactive, scalable, malleable, processible, compoundable and re-vulcanizable, and, therefore, makes it possible to manufacture newly vulcanized or chemically coagulated products/articles/items, with or without using molds, with or without other polymers, elastomers, vulcanizing agents, compatibilizers or other diverse additives.

Injection mold or extruded thermoplastics, like polypropylene, polyethylene,—are also metastalizable by the same mechanical-only process or machine, for example, metactivator. Metastabilized thermoplastics also have several advantages at its utilization level, such as it homogenises better with dyes.

TABLE 1

| | Measure | | | | | |
|---|---|---|---|---|---|---|
| | | Specific | Specific | Specific | | |
| | Density | surface | heat | volume | Expansion | Devulcanization |
| Group | g/cm³ | cm²/g | 30°/160° C. | cm³/g | rate | rate |
| Group 1 | variable | variable | variable | variable | ? | low-mini |
| (grinding.granule/powder) | 0.494 ? | 0.01 ? | 1.5/1.8 ? | 0.848 ? | | <20% ? |
| Group 2 | 0.454 | 0.08 | 1.8/2.1 | 0.956 | 1.01-1.40 | high-maxi |
| (metactivation <0.4 mm) | lower than | higher than | higher than | higher than | | >20% |
| | the origin | the origin | the origin | the origin | | |
| Group 3 | variable | variable | ? | ? | ? | very-high maxi |
| (high temp. pressure) | | 0.2-5.0 ? | | | | >50% ? |

| | Measure | | | | |
|---|---|---|---|---|---|
| | | Spontaneous | | | |
| | Depolymerization | reaction | | | Revulcanization |
| Group | rate | ΔG | Autohesion | Decomposition | Utilization |
| Group 1 | low-mini | no | no | no | not revulcanizable |
| (grinding.granule/powder) | <10% ? | | | in short term | |
| Group 2 | low-mini | yes | yes | yes | revulcanization and |
| (metactivation <0.4 mm) | <30% | | | in short term | very good elastomer |
| Group 3 | very-high maxi | ? | ? | ? | depolymerized |
| (high temp. pressure) | >50% ? | | | | filler in powder/bale |

What is claimed is:

1. The material(s) which is comprised of polymer particles smaller than 3 millimeters (mm) in diameter, whereof the mass is a polymer compound mixed with diverse chemical substances used in the polymer industry, such as fillers (e.g. carbon black), vulcanizing agents (e.g. sulphur), peptizing oils (e.g. aromatic oil), activators (e.g. zinc oxide), accelerators, antioxidants, etc. This polymer material in particles is produced solely through a mechanical process , from pre-vulcanized gum granules (initial material), generally ranging in size from 1 to 5 mm, coming from used rubber products/items (e.g. used tires), rubber product wastes, rubber factory scraps, etc. The aforementioned polymer material(s) in particles does present the following characteristics:
Shape: the surface of the material particles shows a particular shape with micro-grains of 1 to 20 microns, more or less spherical, similar to the grains inside a pomegranate.
Size (mm): measured by granulometry after sieving, the size in diameter of the material particles, identified at the peak position of the Gaussian curve, is on average 2 to 15 times smaller than that of the initial material particles, i.e. pre-vulcanized gum granules.
Bulk density (g/cm³): measured by tapping, the bulk density is on average, 5 to 20% smaller than the initial material, i.e. pre-vulcanized gum granules.
Specific surface (cm²/g): measured by the BET method with Krypton, the specific surface is on average 5 to 20 times higher than that of the initial material, i.e. pre-vulcanized gum granules.
Specific heat (J/° C.g): measured by the DSC/MDSC method, the specific heat is on average 5 to 20% higher than that of the initial material, i.e. pre-vulcanized gum granules.
Devulcanization rate (%): measured by the Swelling technique of Gel fraction according to the Soxhlet method and the Flory-Rehner equation, the devulcanization rate is more than 20%, but varies between 20 and 90%, depending on the initial material, i.e. pre-vulcanized gum granules.
Depolymerization (or, degradation) rate (%): measured by Gel fraction using the Soxhlet method, the depolymerization rate is less than 30%, but is variable between 3% and 30%, depending on the initial material, i.e. pre-vulcanized gum granules.

2. The material in accordance with claim 1, whereof the expansion rate, measured by pycnometry, varies on average from 1.01 to 1.40 depending on the initial material, i.e. pre-vulcanized gum granules.

3. The material in accordance with claim 2, whereof a particle is micro-disintegrated, or micro-separated or micro-pulverized, observed under a microscope, into a large number on average 20-3,000, of micro-grains sized 1-20 microns by mechano-physical ways (e.g. extrusion, kneading, pressure, heat) or by chemical substances (e.g. THF, phenols).

4. The material in accordance with claim 3, and in case of used tires gum, whereof the thermal reaction, measured by Argon DSC/MDSC , shows an endothermic reaction of up to approximately 80° C., but, afterward, a clearly exothermic reaction of about 80° C. to 140° C., and, thereafter, of 160° C. up to about 210° C., depending on the initial material, i.e. pre-vulcanized gum granules.

5. The material in accordance with claim 3 or 4, and produced from used tires gum, whereof the absorption/absorbance rate is about 2 to 5 times higher than that of used tire's gum granules (initial material), particularly near IR frequency 700, 880, 920, 970, 1060, 1000-1250, 1372, 1447, 1539 and 2915 between 650 and 4000.

6. The material in accordance with claim 3 or 4 or 5, which is indeed reactive, scalable, malleable, processible, compoundable and re-vulcanizable, and, therefore, makes it possible to manufacture newly vulcanized or chemically coagulated products/articles/items, with or without using moulds, with or without other polymers, elastomers, vulcanizing agents, compatibilizers or other diverse additives.
